(19) United States
(12) Patent Application Publication
(10) Pub. No.: US 2009/0197464 A1
(43) Pub. Date: Aug. 6, 2009

(54) INTERFACE ADAPTOR

(76) Inventors: Douglas John Hardy, Middletown, PA (US); John Wesley Hall, Harrisburg, PA (US)

Correspondence Address: Lisa Burgin Vaccarelli;Tyco Technology Resources, Suite 140, 4550 New Linden Hill Road, Wilmington, DE, 19808, US

(21) Appl. No.: 12/027,203

(22) Filed: Feb. 6, 2008

(51) Int. Cl. H01R 13/73; H01R 13/648; H01R 29/00

(52) U.S. Cl. 439/559; 439/166; 439/544

(57) ABSTRACT

An interface adaptor includes a housing having a cartridge chamber and an opening providing access to the cartridge chamber. The housing includes a first mating interface and a second mating interface. A cartridge is received in the cartridge chamber through the opening and is removable from the cartridge chamber through the opening. The cartridge includes a substrate, a first header, and a second header. The first header is mounted to the substrate and is provided at the first mating interface for mating with a first connector, and the second header is mounted to the substrate and is provided at the second mating interface for mating with the second connector.

### BACKGROUND OF THE INVENTION

The subject matter herein relates generally to connector assemblies and systems, and more particularly, to an interface adaptor for a connector system.

Motor vehicles and other equipment include various electronic devices mounted therein. The devices may control various systems and/or subsystems. For example, the motor vehicle may include an audio system or a global positioning system (GPS) therein. It may be desirable for the operator of the vehicle to transmit data between the various electronic devices and an external device, such as a personal computer (PC), a personal digital assistant (PDA), an audio device, such as an MP3 player, a cell phone or other external devices. Other examples of electronic devices on the motor vehicle may include a control computer that controls systems within the motor vehicle such as the fuel system, the transmission, the brakes or the steering mechanism. These control computers are typically coupled to a variety of sensors and/or actuators and the control computers may log data regarding usage of the vehicle, such as maximum speed, fuel usage, maximum acceleration, hours of usage, and the like. It may be desirable to communicate with such control computers for maintenance, diagnostics, and the like.

Accordingly, at least some motor vehicles and equipment include a communication port that provides a communication bridge between the electronic devices mounted in the vehicle and the various external devices. For example, some motor vehicles include a Universal Serial Bus (USB) interface, or other type of interface, to facilitate communication between the devices carried by the motor vehicle and the external devices. The USB interface allows repeated connection of the various types of external devices. However, over time, and with repeated use, the USB interface may wear or become damaged, which may degrade or eliminate the signal communicated across the communication bridge. For example, the USB interface may have a limited number of use cycles. Additionally, the USB interface may become contaminated by dirt, debris, a liquid spill, and the like. As such, the USB interface may require repair or replacement over time.

Conventional USB interfaces in motor vehicles and equipment include a USB header soldered to a circuit board of the device. When the USB interface needs replacement, a new circuit board and USB header is provided to replace the existing one. Such a repair is costly, as the USB header is typically the component that may need to be replaced.

Accordingly, a need remains for a connector assembly for a motor vehicle that can be manufactured and replaced in a cost effective and reliable manner.

### BRIEF DESCRIPTION OF THE INVENTION

In one embodiment, an interface adaptor is provided including a housing having a cartridge chamber and an opening providing access to the cartridge chamber. The housing includes a first mating interface and a second mating interface. A cartridge is received in the cartridge chamber through the opening and is removable from the cartridge chamber through the opening. The cartridge includes a substrate, a first header, and a second header. The first header is mounted to the substrate and is provided at the first mating interface for mating with a first connector, and the second header is mounted to the substrate and is provided at the second mating interface for mating with the second connector.

Optionally, the headers may be provided at opposed ends of the substrate. The substrate may be a circuit board having a first end and a second end, wherein the first header is mechanically and electrically connected to the first end of the circuit board, and the second header is mechanically and electrically connected to the second end of the circuit board. Optionally, the headers may be of different types. The substrate may include at least one locating feature for locating the substrate within the cartridge chamber. The housing may include a cover that is hingedly coupled thereto, and the cover may be movable between an open position and a closed position, wherein the cartridge is removable from the cartridge chamber when the cover is in the open position. Optionally, the cartridge may be replaceable and the housing may be reusable.

In another embodiment, a cartridge for an interface adaptor is provided, wherein the cartridge includes a substrate having a first end and a second end. A first header is mounted to the first end of the substrate, wherein the first header is configured for mating with a first connector. A second header is mounted to the second end of the substrate, wherein the second header is configured for mating with a second connector. The substrate is configured to be loaded into a housing of the interface adaptor.

In a further embodiment, a connector system is provided that includes a bezel having a connector interface and a shroud extending generally away from the connector interface, and a interface adaptor mounted to the shroud. The interface adaptor includes a housing having a cartridge chamber and an opening providing access to the cartridge chamber. The housing also includes a first mating interface and a second mating interface, and the housing has at least one latching feature for latching engagement with the bezel. The interface adaptor also includes a cartridge received in the cartridge chamber through the opening that is removable from the cartridge chamber through the opening. The cartridge includes a substrate, a first header, and a second header. The first header is mounted to the substrate and is provided at the first mating interface for mating with a first connector. The second header is mounted to the substrate and is provided at the second mating interface for mating with the second connector.

### BRIEF DESCRIPTION OF THE DRAWINGS

FIG. 1 is an exploded view of a connector system including an interface adaptor formed in accordance with an exemplary embodiment.

FIG. 2 illustrates the interface adaptor shown in FIG. 1 with a cover of the interface adaptor in an open position showing a cartridge held therein.

FIG. 3 is a top perspective view of the cartridge shown in FIG. 2.

FIG. 4 is a front perspective view of a first mating interface of the interface adaptor.

FIG. 5 is a rear perspective view of a second mating interface of the interface adaptor.

FIG. 6 illustrates an alternative embodiment of an interface adaptor for the connector system illustrated in FIG. 1.

FIG. 7 illustrates the connector system using the alternative interface adaptor shown in FIG. 6.

### DETAILED DESCRIPTION OF THE INVENTION

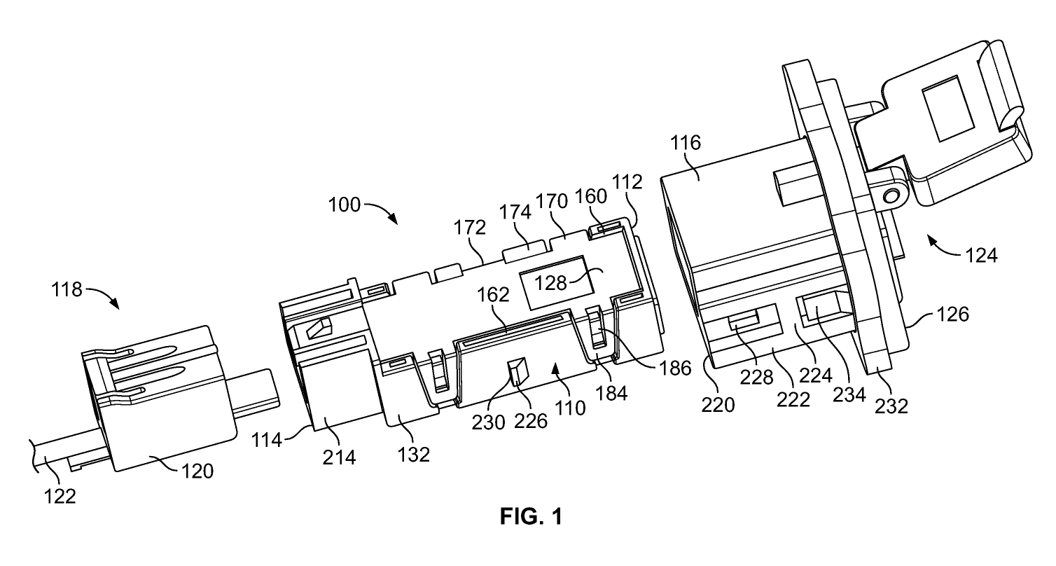

FIG. 1 is an exploded view of a connector system 100 including an interface adaptor 110 formed in accordance with an exemplary embodiment. While the illustrated embodiment shows a USB connector, one skilled in the art would know the disclosed features may be used on other connector types. Moreover, while the system 100 described herein is described as being adapted for USB type of connections, it is realized that other types of electrical interconnection systems may be used within the spirit and scope of the subject matter herein, and the system 100 should not be limited to USB headers and USB connectors.

The interface adaptor 110 includes a first mating end 112 and a second mating end 114. The system 100 also includes a bezel 116 and a cable assembly 118 having an internal connector 120 provided at an end of a cable 122. The interface adaptor 110 is coupled to the bezel 116 at the first mating end 112. The interface adaptor 110 is configured for mating with an external mating connector (not shown), such as a mating connector of an external device, through the bezel 116, as will be described in further detail below. The internal connector 120 of the cable assembly 118 is mated to the interface adaptor 110 at the second mating end 114.

In an exemplary embodiment, the bezel 116 is mounted within a motor vehicle or piece of equipment (not shown). A mating interface 124 is provided at a front side 126 of the bezel 116. The mating interface 124 is presented on, or within, the motor vehicle or piece of equipment for mating with the external mating connector of an external device. The external device may be a device such as an MP3 player, a PC, a PDA, a diagnostic device, and the like. The internal connector 120 is connected to the interface adaptor 110 and the other end of the cable 122 is connected to an electronic device (not shown). The cable 122 may be directly terminated to the electronic device, or alternatively, a connector, such as a USB connector, may be provided at the end of the cable for interfacing with the electronic device. The electronic device may be any electronic device, but in an exemplary embodiment, the electronic device is mounted within the vehicle or piece of equipment and the cable assembly 118 is wired within the motor vehicle or equipment. Examples of electronic devices may include, but are not limited to, an audio system, a GPS system, a control computer, and the like.

While the system 100 is shown and described as including the bezel 116, which is mounted within a motor vehicle or piece of equipment, it is realized that the bezel 116 and/or the interface adaptor 110 may be mounted within any appropriate type of electronic device. The mounting described herein is intended as illustrative and is not intended to be limited to a motor vehicle or piece of equipment, be it industrial or motive. For example, the bezel 116 may be mounted in any type of electronic device. Additionally, the interface adaptor 110 may be mounted without the use of the bezel 116 in some alternative embodiments.

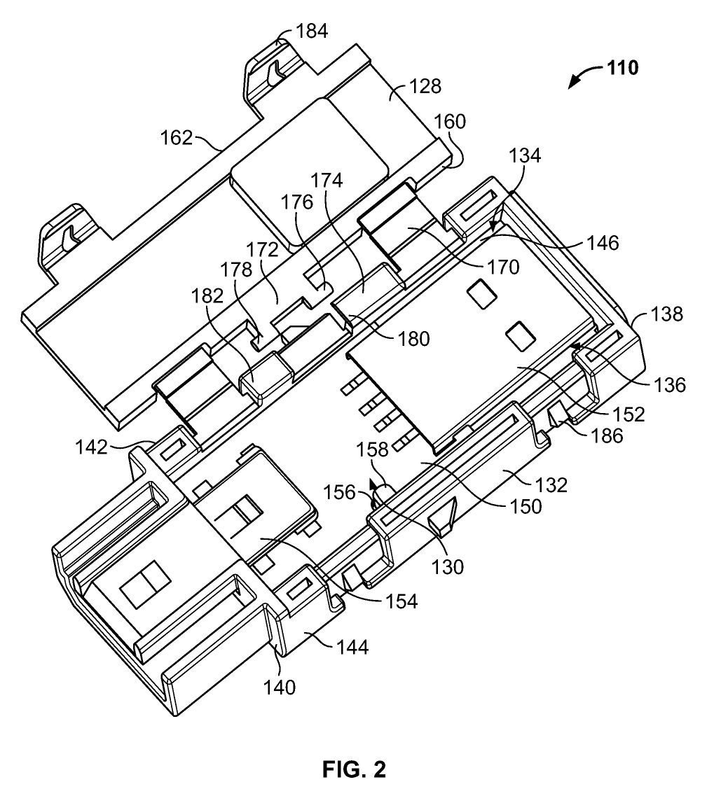

FIG. 2 illustrates the interface adaptor 110 with a cover 128 of the interface adaptor 110 in an open position showing a cartridge 130 held therein. The connector assembly 110 includes a housing 132 having a plurality of walls defining a cartridge chamber 134. The cartridge 130 is received in the cartridge chamber 134. An opening 136 provides access to the cartridge chamber 134. In an exemplary embodiment, the cartridge 130 is loaded into the cartridge chamber 134 through the opening 136. The cover 128 closes access to, or otherwise closes, the opening 136 and/or the cartridge chamber 134. In an exemplary embodiment, the housing 132 is generally box-shaped having a first end wall 138 at the first mating end 112, a second end wall 140 at the second mating end 114, opposed first and second side walls 142, 144, and a bottom wall 146. The top includes the opening 136. While the housing 132 is illustrated as being box-shaped, the housing 132 may have any shape that is configured to receive the cartridge 130.

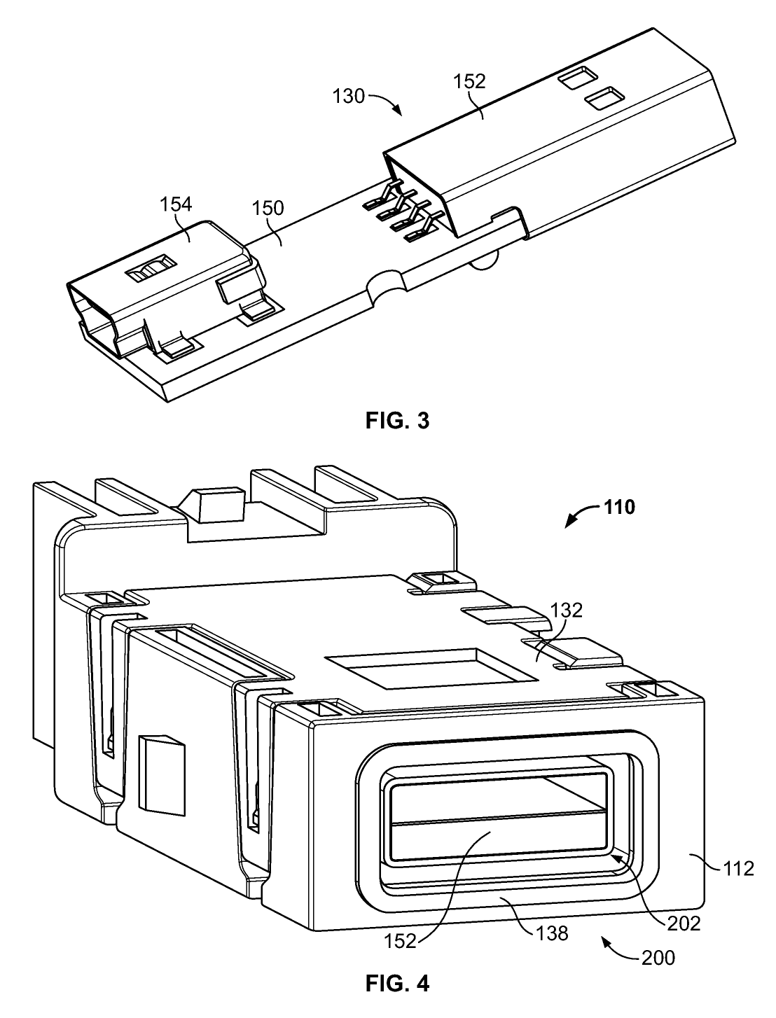

FIG. 3 is a top perspective view of the cartridge 130 shown in FIG. 2. The cartridge 130 includes a substrate 150 (e.g. a circuit board, flex film, and the like), a first header 152 electrically and mechanically connected to a first portion of the substrate 150, and a second header 154 electrically and mechanically connected to a second portion of the substrate 150. In the illustrated embodiment, the first and second headers 152, 154 are mounted to the top side of the substrate 150 at opposed ends of the substrate 150. Other mounting configurations are possible in alternative embodiments, such as stacked, off-set, non-aligned or right angle configurations. Additionally, in some alternative embodiments, the substrate 150 may include a leadframe or wire harness directly connecting the headers 152, 154. The leadframe may or may not be encased within a body, such as by an overmolding process.

In an exemplary embodiment, the first and second headers 152, 154 define interfaces that are different than one another. In the illustrated embodiment, the first and second headers 152, 154 define USB interfaces. For example, the headers may be one of a USB type A, a USB type B, a mini-USB type A, a mini-USB type B, a micro-USB type A, a micro-USB type B, or another USB type. In the illustrated embodiment, the first USB header 152 defines a USB type A receptacle interface, and the second USB header 154 defines a mini-USB type B receptacle interface. Optionally, as illustrated in FIG. 3, the headers 152, 154 may be non-USB types of interfaces.

Returning to FIG. 2, the cartridge 130 is loaded into the cartridge chamber 134 such that the first header 152 is provided proximate the first end wall 138. The cartridge 130 is loaded into the cartridge chamber 134 such that the second header 154 is provided proximate the second end wall 140. In an exemplary embodiment, the substrate 150 of the cartridge 130 includes a keying feature 156 and the housing 132 includes a keying feature 158. The keying features 156, 158 orient the cartridge 130 within the cartridge chamber 134. Optionally, the cartridge 130 may be held within the cartridge chamber 134 by a friction fit with the walls of the housing 132. Alternatively, a securing element may be used to secure the cartridge 130 in place.

The cover 128 is provided for closing access to the cartridge chamber 134. The cover 128 is movable between an open position, such as the position shown in FIG. 2, and a closed position, in which the opening 136 is closed. In the illustrated embodiment, the cover 128 is generally rectangular shaped and includes opposed first and second sides 160, 162. Alternatively, the shape of the cover 128 may be non-rectangular, depending on the shape of the opening 136. In an exemplary embodiment, the first side 160 of the cover 128 is hingedly connected to the first side wall 142 by hinges 170. Optionally, the cover 128, housing 132 and hinges 170 may be integrally formed, such as by a molding process.

The first side 160 of the cover 128 includes a cover catch 172 extending therefrom. The first side wall 142 includes a locking element 174. When the cover 128 is closed, the cover catch 172 engages the locking element 174 to secure the first side 160 against the housing 132. In an exemplary embodiment, the cover catch 172 includes a first protrusion 176 in the form of a pin and a second protrusion 178 also in the form of a pin. The locking element 174 includes first and second lids 180, 182 formed in, or extending from, the first side wall 142. The protrusions 176, 178 are captured below the lids 180, 182 when the cover 128 is closed.

The second side 162 of the cover 128 includes securing elements 184 that are configured to engage corresponding securing elements 186 on the second side wall 144 of the housing 132. The securing elements 184 on the cover 128 may include, and are referred to hereinafter as, latches 184. The securing elements 186 on the housing 132 may include, and are referred to hereinafter as, latching tabs 186. The latches 184 extend generally perpendicular to the cover 128 and extend along the second side wall 144 when the cover is in the closed position. The latching tabs 186 extend outward from the second side walls 144 and are sized and shaped to fit into apertures in the latches 184. Alternative securing elements 184, 186 may be provided in alternative embodiments to securely retain the second side 162 of the cover against the housing 132.

FIG. 4 is a front perspective view of a first mating interface 200 of the interface adaptor 110. The first mating interface 200 is provided at the first mating end 112 of the interface adaptor 110. The housing 132 includes an opening 202 through the first end wall 138 that provides access to the first mating interface 200. In an exemplary embodiment, the first header 152 is a USB receptacle that receives a USB plug therein. The opening 202 is sized and shaped to receive the USB plug of the mating connector (not shown).

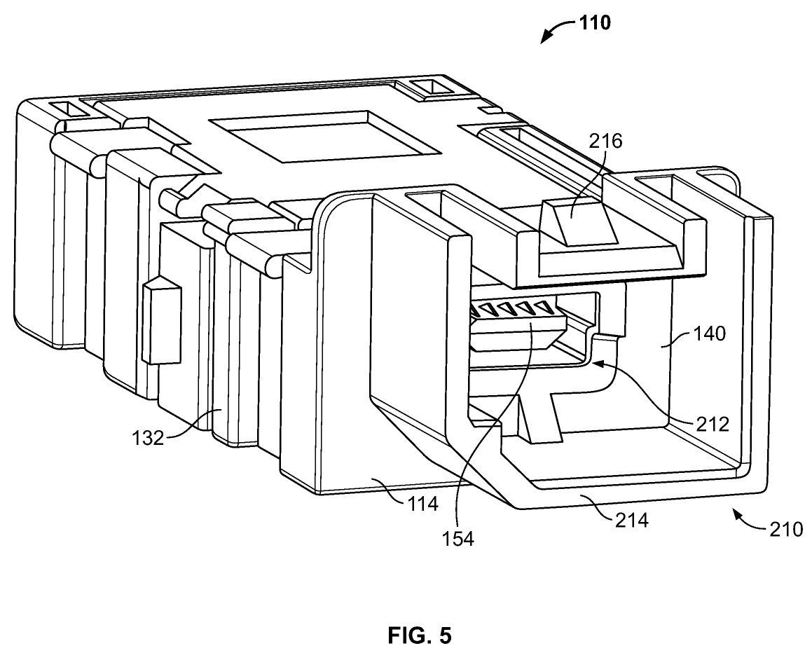

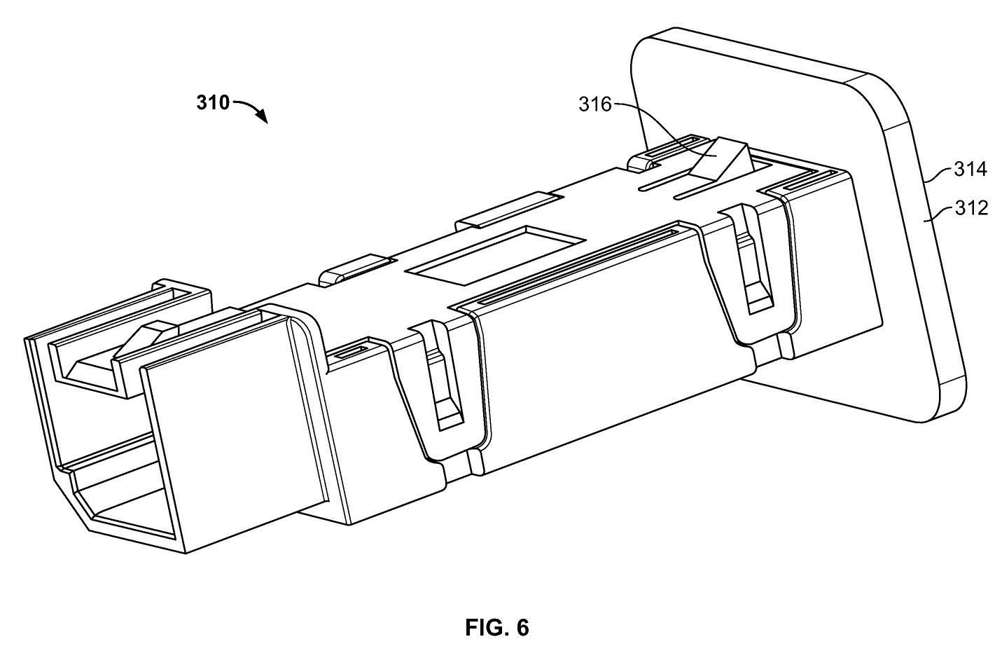

FIG. 5 is a rear perspective view of a second mating interface 210 of the interface adaptor 110. The second mating interface 210 is provided at the second mating end 114 of the interface adaptor 110. The housing 132 includes an opening 212 through the second end wall 140 that provides access to the second mating interface 210. In an exemplary embodiment, the second header 154 is a USB receptacle that receives the internal connector 120 (shown in FIG. 1) therein. The opening 212 is sized and shaped to receive the internal connector 120. In an exemplary embodiment, a shroud 214 extends from the second end wall 140 that is configured to mate with the internal connector 120. The shroud 214 may be keyed to orient the internal connector 120 within the shroud 214. The shroud 214 may include a latching feature, such as a catch 216, or other type of securing element, for mating engagement with the internal connector 120.

An exemplary assembly operation is described with reference back to FIG. 1. Once the cartridge 130 (shown in FIG. 3) is loaded into the housing 132, the cover 128 is closed. For example, the cover 128 is rotated to the closed position about the hinges 170. The latches 184 are securely engaged with the latching tabs 186 (shown in FIG. 2). The latches 184 keep the second side 162 of the cover 128 closed against the housing 132. The hinges 170 keep the first side 160 of the cover 128 closed against the receptacle housing 132. Although the hinges 170 are intended for multiple uses, it is possible that the hinges 170 may break due to use and/or due to the environment in which the connector assembly 110 is operated. For example, in a motor vehicle, the connector assembly 110 may be subjected to vibrations and other sudden movements that may cause the hinges to break. The cover catch 172 is employed to additionally secure the first side 170 of the cover 128 closed against the housing 132. The cover catch 172 and the locking element 174 supplement the hinges 170 in keeping the cover 128 closed, and thus operate as a secondary securing element. Alternatively, when closed, the cover catch 172 may operate as a primary securing element by substantially eliminating stress on the hinge 170, thus leading to extended hinge life.

The interface adaptor 110 is presented to a rear side 220 of the bezel 116. The first mating end 112 is plugged into a shroud 222 of the bezel 116 that extends rearward from the mating interface 124 of the bezel 116. The bezel 116 includes latching features 224 and the interface adaptor 110 includes latching features 226. The interface adaptor 110 is plugged into the shroud 220 until the latching features 224 of the shroud 220 engage the latching features 226 of the interface adaptor 110. In an exemplary embodiment, the latching features 224 of the shroud 220 define deflectable latches 224 and the latching features 226 of the receptacle housing 110 define ramps 226 that extend outward from the side walls 142, 144. The deflectable latches 224 include openings 228 therein that are sized and shaped to receive the ramps 226. During mating, the deflectable latches 224 are deflected outward as the interface adaptor 110 is loaded into the shroud 220. When mated, the deflectable latches 224 are deflected to securely retain the interface adaptor 110 within the shroud 220. For example, the ramps 226 may be received within the openings 228 and a rear end 230 of the ramps 226 may engage the opening 228 to resist removal of the interface adaptor 110 from the shroud 220. Alternative latching features known in the art may be used to securely retain the connector assembly 100 within the shroud 220.

Either before or after the interface adaptor 110 is connected to the bezel 116, the internal connector 120 is connected to the interface adaptor 110 at the second mating end 114. The internal connector 120 is plugged into the shroud 214. Once the internal connector 120 is connected, and the interface adaptor 110 is provided at the mating interface 124, the interface adaptor 110 is configured to receive a mating connector (not shown). The interface adaptor 110 thus defines a communication bridge that interconnects the internal connector 120, which is connected to an electronic device within the motor vehicle or equipment, with an external mating connector or external device, such as an audio system, a GPS system, a control computer, and the like. In an exemplary embodiment, the bezel 116 is mountable to a frame or other structure 232 of the motor vehicle or equipment. For example, the bezel 116 may be front loaded through an opening in the frame 232 and secured thereto using a clip 234 or other fastening element. The bezel 116 may also be released from the frame 232 and can be pulled through the opening in the frame 232 for accessing the interface adaptor 110 and/or the cable assembly 118, such as for maintenance, repair, and/or replacement.

In an exemplary embodiment, if the communication bridge were to be damaged, such as by the first header 152 (shown in FIG. 3) becoming damaged or worn, then the connector system 100 may be taken apart for service. For example, the interface adaptor 110 may be removed from the bezel 116, the cover 128 may be opened, and the cartridge 130 (shown in FIG. 3) may be removed and replaced with a different cartridge. The housing 132 is reusable and may be used with the different cartridge, thus reducing the maintenance, repair and/or replacement cost of the connector system 100. Similarly, if a different type of interface were to be used with the connector system 100, then the interface adaptor 110 could be accessed in a similar manner, and a different cartridge having different types of interfaces may be placed within the housing 132.

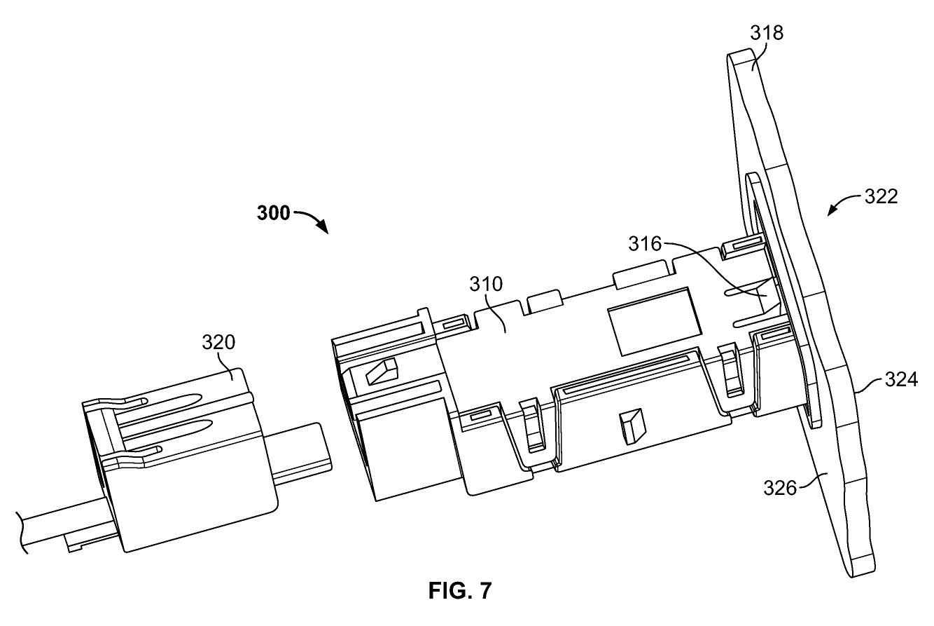

FIG. 6 illustrates an alternative interface adaptor 310 for an alternative connector system 300 (shown in FIG. 7). The interface adaptor 310 is similar to the interface adaptor 110 shown in the previous figures in some aspects. One difference is that the interface adaptor 310 includes a flange 312 at a first mating end 314. The interface adaptor 310 also includes a latch 316 proximate the flange 312. The latch 316 and the flange 312 cooperate to secure the interface adaptor 310 in position within the motor vehicle or equipment.

FIG. 7 illustrates the connector system 300 using the alternative interface adaptor 310. The interface adaptor 310 is illustrated as being mounted to a bezel 318. In one embodiment, the interface adaptor 310 may be directly mounted to the frame or other support structure, rather than the bezel 318, or alternatively, the frame may operate as the bezel 318. The bezel 318 is captured between the latch 316 and the flange 312 (shown in FIG. 6). An internal connector 320 is provided for mating with the interface adaptor in a similar manner as the internal connector 120 (shown in FIG. 1). The interface adaptor 310 is also configured to mate with an external mating connector of an external electric device, in a similar manner as the interface adaptor 110 (shown in FIG. 1).

Assembly of the interface adaptor 310 is accomplished by loading the interface adaptor 310 through an opening in the bezel 318 through a mating interface 322 of the bezel 318. The bezel 318 includes a front side 324 having the mating interface 322 and a rear side 326. The interface adaptor 310 is loaded through the front side 324 and extends from the rear side 326 when mounted to the bezel 318. The flange 312 is exposed at the mating interface 322. The interface adaptor 310 may be removed from the bezel 318 by releasing the latch 316 and pulling the interface adaptor 310 through the opening in the bezel 318.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. § 112, sixth paragraph, unless and until such claim limitations expressly use the phrase “means for” followed by a statement of function void of further structure.

What is claimed is:

1. An interface adaptor comprising:
a housing having a cartridge chamber and an opening providing access to the cartridge chamber, and the housing including a first mating interface and a second mating interface; and
a cartridge received in the cartridge chamber through the opening and being removable from the cartridge chamber through the opening, the cartridge includes a substrate, a first header, and a second header, the first header being mounted to the substrate and provided at the first mating interface for mating with a first connector, and the second header being mounted to the substrate and provided at the second mating interface for mating with a second connector.

2. The adaptor of claim 1, wherein the first and second headers are provided at opposed ends of the substrate.

3. The adaptor of claim 1, wherein the substrate is a circuit board having a first end and a second end, the first header mechanically and electrically connected to the first end of the circuit board, and the second header mechanically and electrically connected to the second end of the circuit board.

4. The adaptor of claim 1, wherein the first and second headers are of different types.

5. The adaptor of claim 1, wherein the substrate includes at least one locating feature for locating the substrate within the cartridge chamber.

6. The adaptor of claim 1, wherein the housing includes a cover hingedly coupled thereto, the cover being movable between an open position and a closed position, wherein the cartridge is removable from the cartridge chamber when the cover is in the open position.

7. The adaptor of claim 1, wherein the housing is configured to be mated with a bezel, the housing includes latching features for latching engagement with the bezel.

8. The adaptor of claim 1, wherein the cartridge is replaceable and the housing is reusable.

9. The adaptor of claim 1, wherein the housing includes a cover catch extending therefrom and a cover having at least one locking element, the cover catch is engaged with the locking element when the cover is in a closed position and the cover catch is dis-engaged from the locking element when the cover is in an open position.

10. The adaptor of claim 9, wherein the cover catch includes a protrusion and the locking element includes a lid, the lid resists movement of the protrusion in a direction generally away from the opening.

11. A cartridge for an interface adaptor, the cartridge comprising:
a substrate having a first end and a second end;
a first header mounted to the first end of the substrate, the first header being configured for mating with a first connector; and
a second header mounted to the second end of the substrate, the second header being configured for mating with a second connector;
wherein the substrate is configured to be loaded into a housing of the interface adaptor.

12. The cartridge of claim 11, wherein the first and second headers include mating interfaces that generally face in opposite directions from one another.

13. The cartridge of claim 11, wherein the first and second headers are of different types selected from the group comprising a USB type A, a USB type B, a mini-USB type A, a mini-USB type B, a micro-USB type A, and a micro-USB type B.

14. The cartridge of claim 11, wherein the first and second headers are substantially co-planar.

15. A connector system comprising:
a bezel having a connector interface and a shroud extending generally away from the connector interface; and
an interface adaptor mounted to the shroud, the interface adaptor comprising:
a housing having a cartridge chamber and an opening providing access to the cartridge chamber, and the housing includes a first mating interface and a second mating interface, the housing having at least one latching feature for latching engagement with the bezel; and
a cartridge received in the cartridge chamber through the opening and being removable from the cartridge chamber through the opening, the cartridge includes a substrate, a first header, and a second header, the first header being mounted to the substrate and provided at the first mating interface for mating with a first connector, and the second header being mounted to the substrate and provided at the second mating interface for mating with the second connector.

16. The system of claim 15, wherein the first and second headers are of different types.

17. The system of claim 15, wherein the receptacle housing is pluggable into the shroud, the shroud includes a latching feature that cooperates with the latching feature of the housing to securely couple the housing to the bezel.

18. The system of claim 15, wherein the bezel includes a front side and a rear side, the connector interface is provided on the front side and the shroud is provided on the rear side, the housing is plugged into the shroud from the rear side.

19. The system of claim 15, wherein the bezel includes a front side and a rear side, the connector interface is provided on the front side and the shroud is provided on the rear side, the housing is plugged into the shroud from the front side.

20. The system of claim 15, further comprising a cable assembly having a cable and the second connector provided at the end of the cable, the cable assembly being connected to the interface adaptor at the second mating interface.
